(19) United States
(12) Patent Application Publication
(10) Pub. No.: US 2020/0126047 A1
(43) Pub. Date: Apr. 23, 2020

(54) Digital Check Generation and Processing Platform

(71) Applicant: Bank of America Corporation, Charlotte, NC (US)

(72) Inventors: Robert Megerdichian, Los Angeles, CA (US); Anthony Baklayan, Oak Park, CA (US)

(21) Appl. No.: 16/162,936

(22) Filed: Oct. 17, 2018

(51) Int. Cl. G06Q 20/04; G06Q 20/10; G06Q 20/32

(52) U.S. Cl. CPC G06Q 20/042; G06Q 20/3223; G06Q 20/108

(57) ABSTRACT

Aspects of the disclosure relate to processing systems that generate and process digital check images. The computing platform may receive an encrypted digital check image corresponding to a payment and commands directing the computing platform to store the encrypted digital check image. The computing platform may decrypt the encrypted digital check image, and may store the decrypted digital check image for access through an online banking portal. The computing platform may generate a notification containing a link to the decrypted digital check image, which may be accessible through the online banking portal. The computing platform may generate online banking interface information and commands directing a client device to display an online banking interface, including the notification. The computing platform may receive a check endorsement indication corresponding to the decrypted digital check image and may update the decrypted digital check image to include an endorsement image.

### BACKGROUND

Aspects of the disclosure relate to enhanced processing systems for generating, endorsing, and processing digital check images. In particular, one or more aspects of the disclosure relate to computing platforms that generate and store digital check images that may be accessed and endorsed using graphical user interfaces.

Many organizations and individuals rely on checks as a means for conducting transactions and transferring funds. It may be desirable to improve the user experience of conducting check based transactions, to increase the level of information security corresponding to such transactions, and to decrease the consumption of computing resources and other resources associated with such transactions. In many instances, however, customers may receive a physical check, endorse the physical check, and take a photo of the physical check using a personal computing device in order to conduct a deposit through an online banking interface. This may lead to operational inefficiencies in check based transactions due to the mailing delay that corresponds to the shipping of the physical check, and may lead to security risks as the physical check may slip into the wrong hands and may be cashed or otherwise deposited by an unintended recipient. In addition, printing physical checks may be resource intensive due to the paper, ink, or the like needed in production.

### SUMMARY

Aspects of the disclosure provide effective, efficient, scalable, and convenient technical solutions that address and overcome the technical problems associated with the processing and transmission of physical checks. For example, some aspects of the disclosure provide techniques that may enable computing platforms to generate digital check images that may be used to transfer funds between banking accounts. Additional aspects of the disclosure provide techniques for endorsing the digital check images and processing payments corresponding to the digital check images. One or more aspects of the disclosure may enable organizations operating such computing platforms to provide users with the option to receive, endorse, and deposit checks on their personal computing devices instead of or in addition to receiving a physical check.

In accordance with an embodiment of the disclosure, a computing platform comprising at least one processor, a communication interface, and memory storing computer-readable instructions may receive, from an event processing host platform and in response to an indication of a payment, an encrypted digital check image corresponding to the payment and one or more commands directing the computing platform to store the encrypted digital check image. The computing platform may decrypt the encrypted digital check image, resulting in a decrypted digital check image. The computing platform may store the decrypted digital check image for access through an online banking portal hosted by the computing platform. The computing platform may generate a notification containing a link to the decrypted digital check image, which may be accessible through the online banking portal hosted by the computing platform. The computing platform may generate online banking interface information and one or more commands directing a client device to display an online banking interface using the online banking interface information, which may include the notification. The computing platform may receive, from a client device, a check endorsement indication corresponding to the decrypted digital check image. The computing platform may update the decrypted digital check image to include an endorsement image based on the check endorsement indication.

In one or more instances, the computing platform may generate, based on the check endorsement indication, one or more commands directing the event processing host platform to cause a transfer of funds corresponding to the payment. The computing platform may send, to the event processing host platform, the one or more commands directing the event processing host platform to cause the transfer of funds corresponding to the payment.

In one or more instances, the computing platform may establish a wireless data connection with the event processing host platform, and the encrypted digital check image may be received while the wireless data connection with the event processing host platform is established.

In one or more instances, the computing platform may determine a payee corresponding to the payment. The computing platform may establish a correlation between the payee and the notification, which may cause the notification to be displayed in an online banking account corresponding to the payee.

In one or more instances, the computing platform may establish a wireless data connection with the client device, and the check endorsement indication corresponding to the decrypted digital check image may be received while the wireless data connection with the client device is established.

In one or more instances, the computing platform may receive, from the client device, a request to access an online banking account of a payee corresponding to the payment, where the request to access the online banking account corresponding to the payee includes login credentials. Before generating the online banking interface information and the one or more commands directing a client device to display the online banking interface using the online banking interface information, the computing platform may verify the login credentials.

In one or more instances, the computing platform may send the online banking interface information and the one or more commands directing a client device to display the online banking interface using the online banking interface information to the client device.

In one or more instances, the computing platform may store, after updating the decrypted digital check image to include an endorsement image based on the check endorsement indication, the updated decrypted digital check image.

In one or more instances, the computing platform may receive an indication from the event processing host platform indicating that payment was executed and one or more commands directing the computing platform to update the online banking interface to reflect the executed payment. The computing platform may update the online banking interface to reflect the executed payment, which may cause the client device to display the updated online banking interface.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for deploying an enhanced processing system that controls digital check generation and processing in accordance with one or more example embodiments;

FIGS. 2A-2I depict an illustrative event sequence for deploying an enhanced processing system that controls digital check generation and processing in accordance with one or more example embodiments;

FIGS. 3-5 depict example graphical user interfaces for deploying an enhanced processing system that controls digital check generation and processing in accordance with one or more example embodiments; and

FIG. 6 depicts an illustrative method for deploying an enhanced processing system that controls digital check generation and processing in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

One or more aspects of the disclosure relate to generating a digital check image and techniques for payment processing and authentication corresponding to the digital check image. Today, customers may take a picture of a check with their mobile device and deposit the check in their bank account using an online banking mobile application. Some aspects of the disclosure add functionality to the application by sending a notification and a link to a secure image file that may be provided by a financial institution.

Payees that opt in to receive check images, instead of printed checks, may open the check image, e-sign the reverse side on their mobile device screen, and deposit to any of their accounts with the financial institution. In one or more instances, the systems and methods described herein may apply to accounts at an individual financial institution. Additionally or alternatively, the systems and methods described herein may apply to external accounts corresponding to one or more financial institutions.

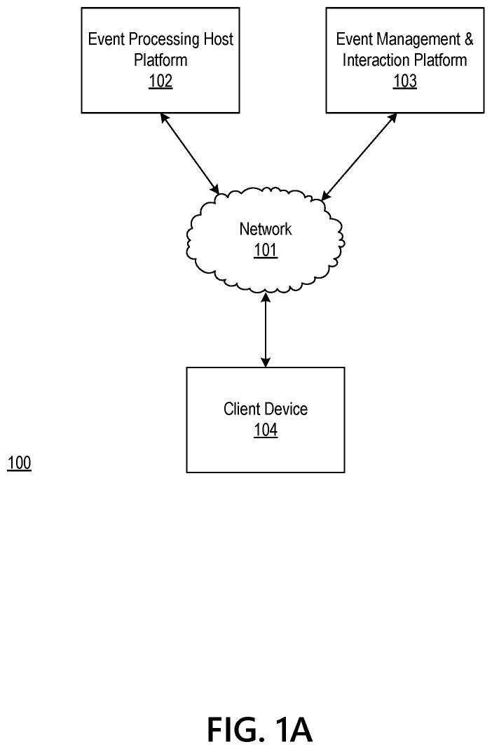

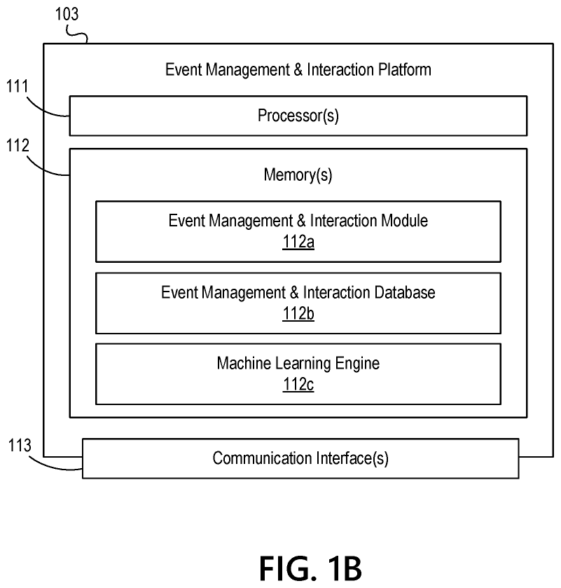

FIGS. 1A-1B depict an illustrative computing environment for deploying an enhanced processing system that controls digital check generation and processing in accordance with one or more example embodiments. Referring to FIG. 1A, computing environment 100 may include one or more computer systems. For example, computing environment 100 may include an event processing host platform 102, an event management and interaction platform 103, and a client device 104.

Event processing host platform 102 may be a computer system that includes one or more computing devices and/or other computer components (e.g., processors, memories, communication interfaces). In addition, event processing host platform 102 may be configured to receive requests (e.g., requests to generate and/or process digital check images, and the like.) In one or more instances, the event processing host platform may be configured to maintain a database of registered payees, and may access the database of registered payees when generating the digital check images.

As illustrated in greater detail below, event management and interaction platform 103 may be configured to generate, host, transmit, and/or otherwise provide graphical user interface information (which may, e.g., cause one or more other computer systems to display and/or otherwise present one or more other graphical user interfaces). In some instances, the graphical user interface information generated by event management and interaction platform 103 may be used to generate online banking interfaces at one or more other computing devices. In one or more instances, the event management and interaction platform 103 may be configured to receive and store the digital check images generated by the event processing host platform 102, and to update the stored digital check images upon determining that the digital check images have been authenticated and/or endorsed. Additionally, or alternatively, the event management and interaction platform 103 may direct the event processing host platform 102 to process a payment corresponding to a digital check image. In one or more instances, the event management and interaction platform 103 may host an online banking database that may allow customers to access various accounts and perform various transactions.

Client device 104 may include one or more computing devices and/or other computer components (e.g., processors, memories, communication interfaces). In addition, and as illustrated in greater detail below, client device 104 may cause display of and/or otherwise present one or more graphical user interfaces. In some instances, the client device 104 may be desktop computer, a laptop computer, a tablet, a mobile device, or the like. In some instances, the graphical user interfaces presented by client may be online banking user interfaces. Such graphical user interfaces, for instance, may provide a customer of an organization, such as a customer of a financial institution, with an opportunity to access, endorse, and deposit the digital check images. In one or more instances, the graphical user interfaces may include notifications, links, or the like to indicate the digital check images, and in some instances, may provide the customer with the ability to endorse the digital check images (e.g., using an electronic signature, a digital stamp, or the like).

Computing environment 100 also may include one or more networks, which may interconnect event processing host platform 102, event management and interaction platform 103, and client device 104. For example, computing environment 100 may include a network 101 (which may interconnect, e.g., event processing host platform 102, event management and interaction platform 103, and client device 104).

In one or more arrangements, event processing host platform 102, event management and interaction platform 103, and client device 104 may be any type of computing device capable of receiving a user interface, receiving input via the user interface, and communicating the received input to one or more other computing devices. For example, event processing host platform 102, event management and interaction platform 103, client device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of event processing host platform 102, event management and interaction platform 103, and client device 104 may, in some instances, be special-purpose computing devices configured to perform specific functions.

Referring to FIG. 1B, event management and interaction platform 103 may include one or more processors 111, memory 112, and communication interface 113. A data bus may interconnect processor 111, memory 112, and communication interface 113. Communication interface 113 may be a network interface configured to support communication between event management and interaction platform 103 and one or more networks (e.g., network 101, or the like). Memory 112 may include one or more program modules having instructions that when executed by processor 111 cause event management and interaction platform 103 to perform one or more functions described herein and/or one or more databases that may store and/or otherwise maintain information which may be used by such program modules and/or processor 111. In some instances, the one or more program modules and/or databases may be stored by and/or maintained in different memory units of event management and interaction platform 103 and/or by different computing devices that may form and/or otherwise make up event management and interaction platform 103. For example, memory 112 may have, host, store, and/or include an event management and interaction module 112a, an event management and interaction database 112b, and a machine learning engine 112c. Event management and interaction module 112a may have instructions that direct and/or cause event management and interaction platform 103 to execute advanced event management techniques, as discussed in greater detail below. Event management and interaction database 112b may store information used by event management and interaction module 112a and/or event management and interaction platform 103 in executing event management techniques and/or in performing other functions. In one or more instances, in executing the event management techniques, the event management and interaction platform may facilitate access to, endorsement of, and processing of digital check images. Machine learning engine 112c may have instructions that direct and/or cause the event management and interaction platform 103 to perform event management and to set, define, and/or iteratively refine optimization rules and/or other parameters used by the event management and interaction platform 103 and/or other systems in computing environment 100.

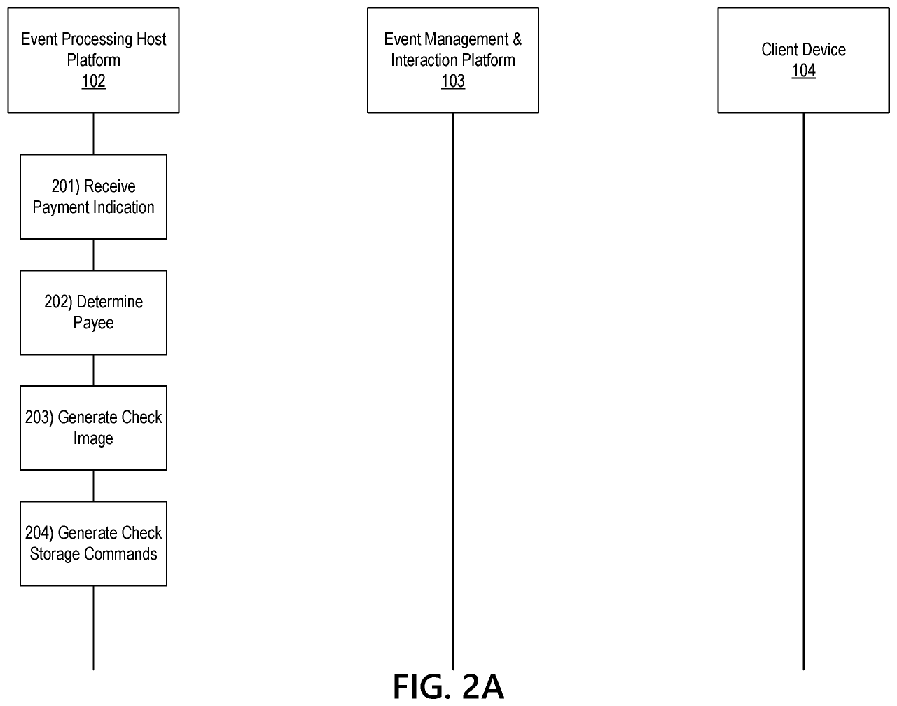

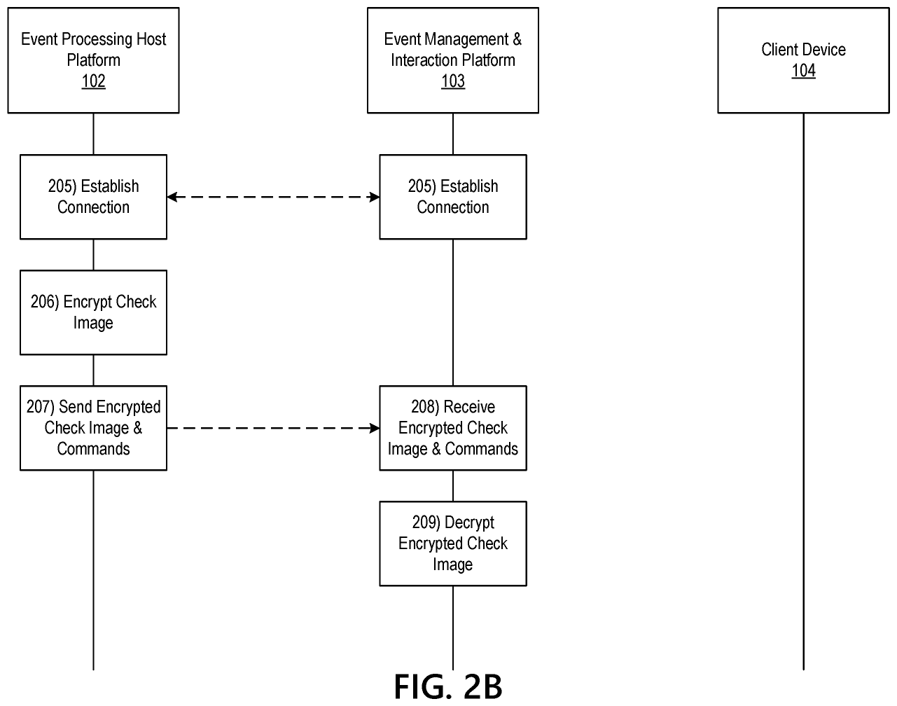

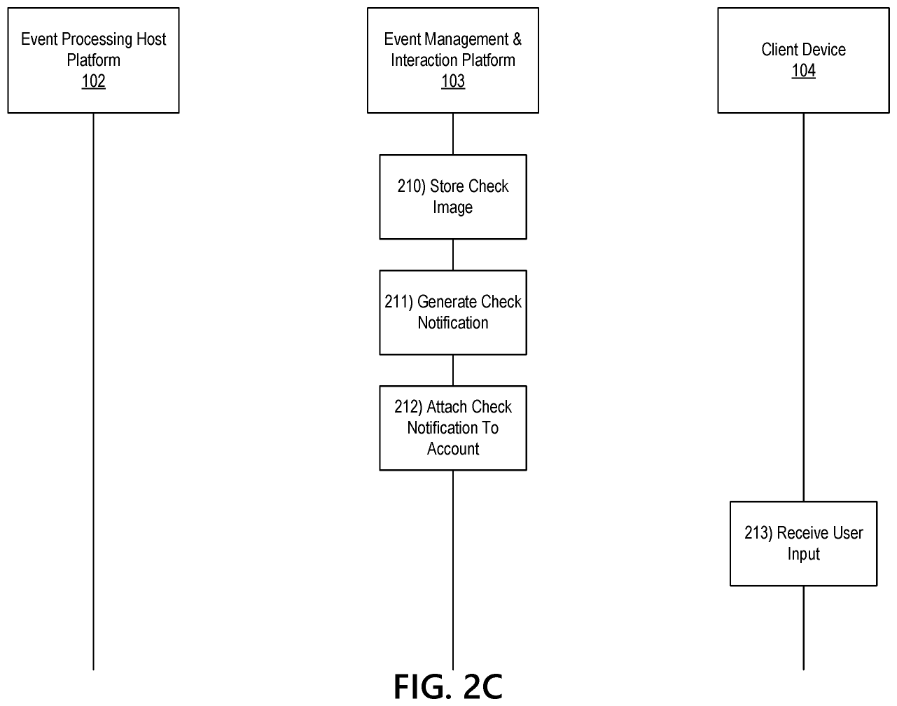

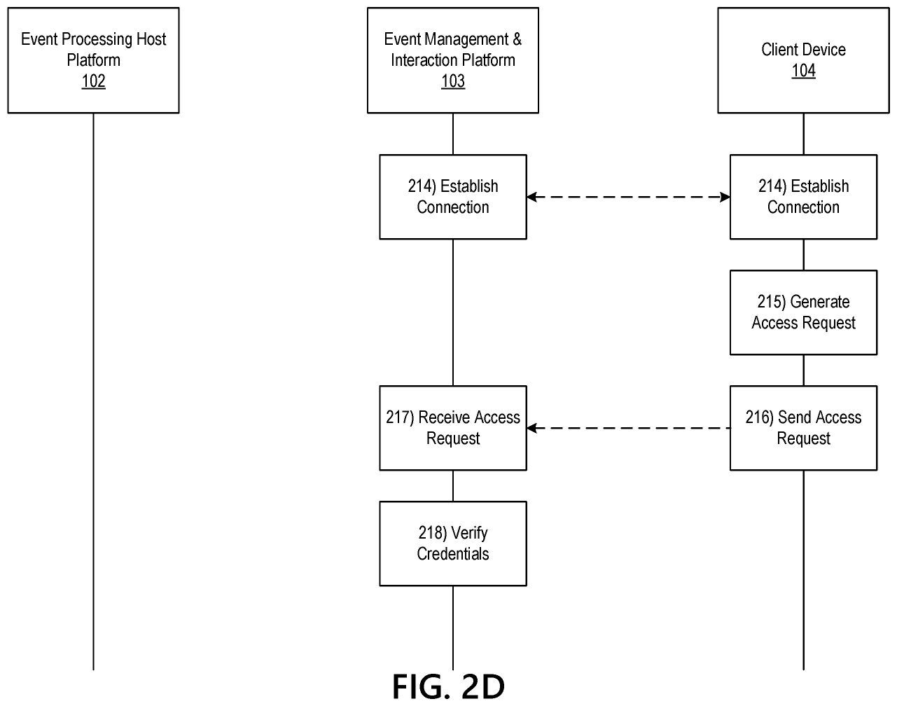

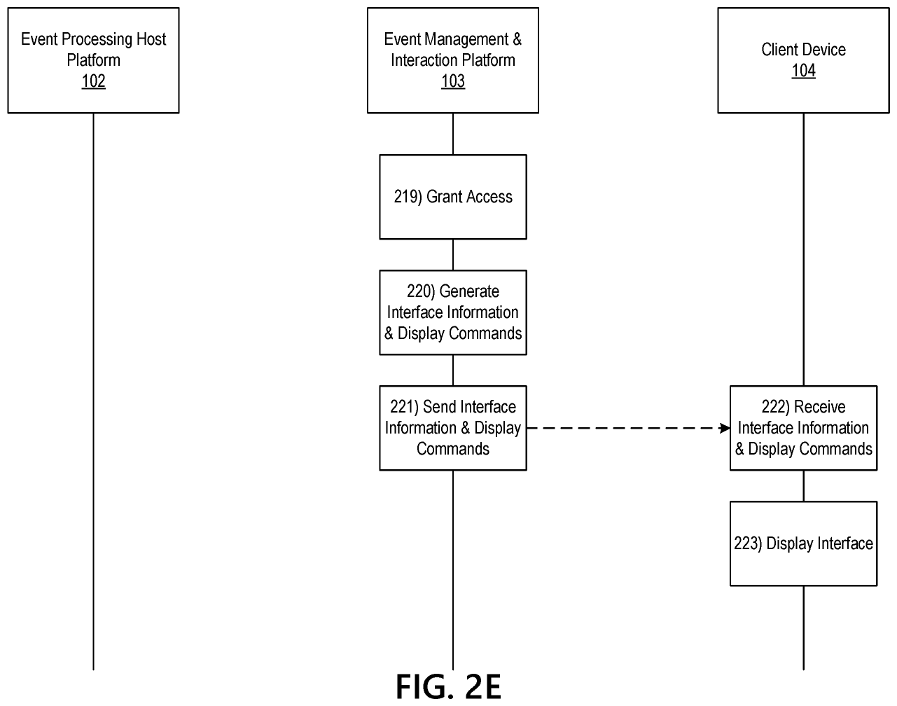

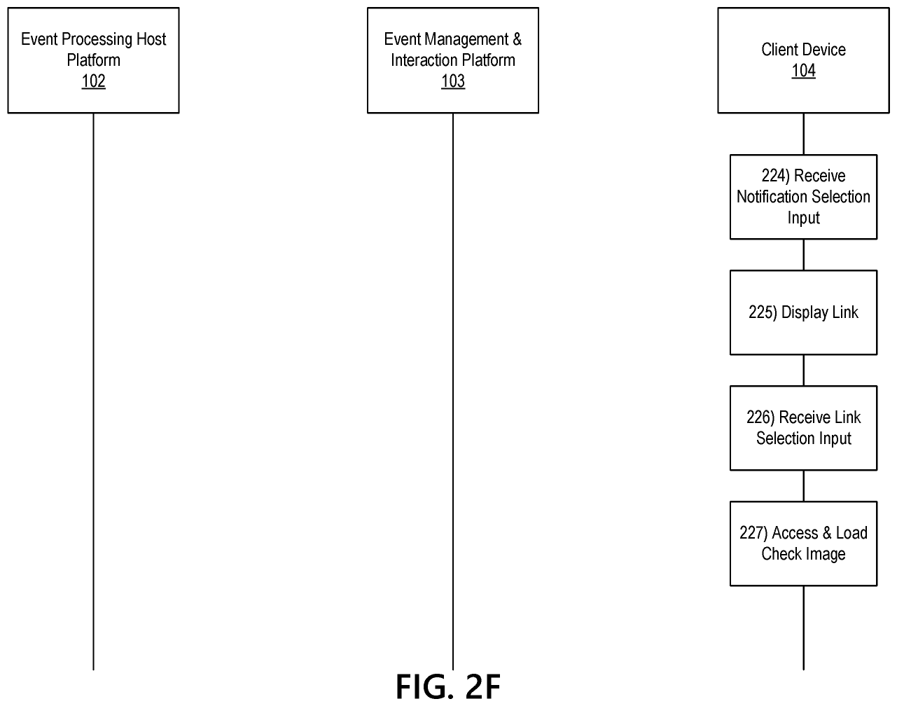

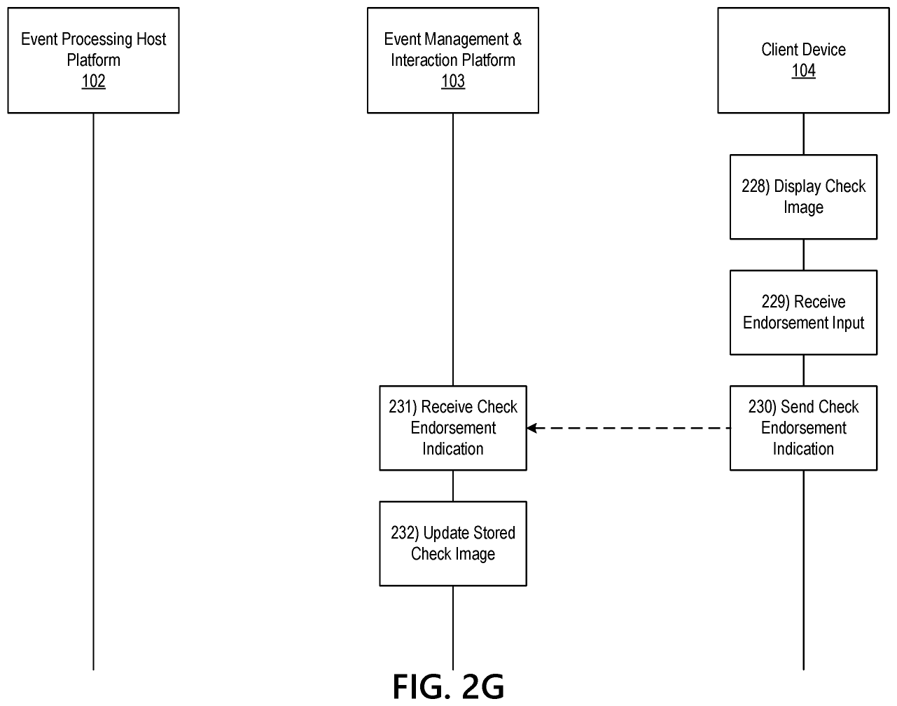

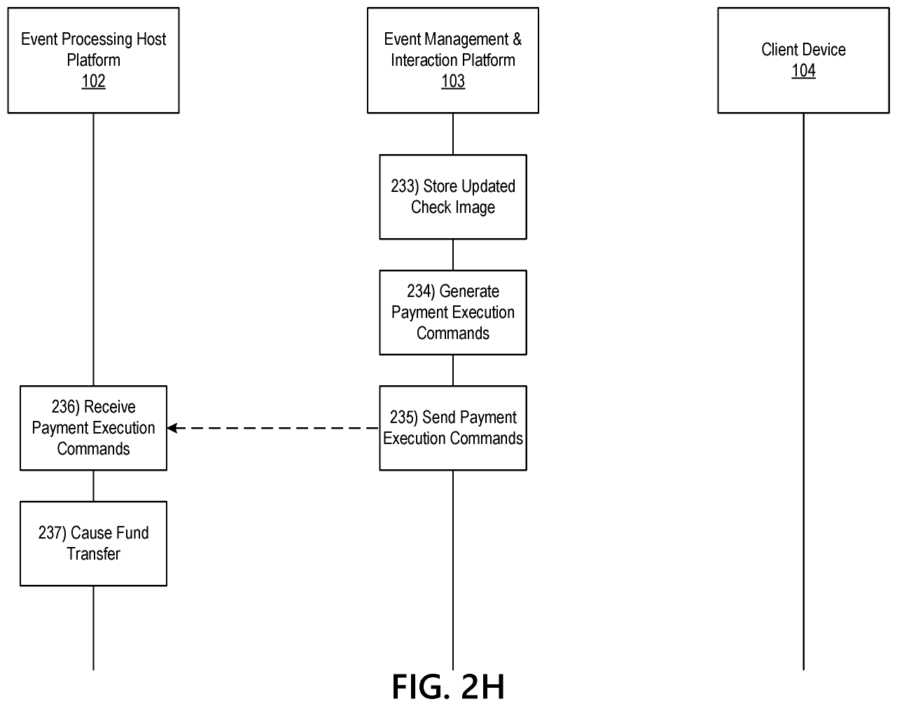

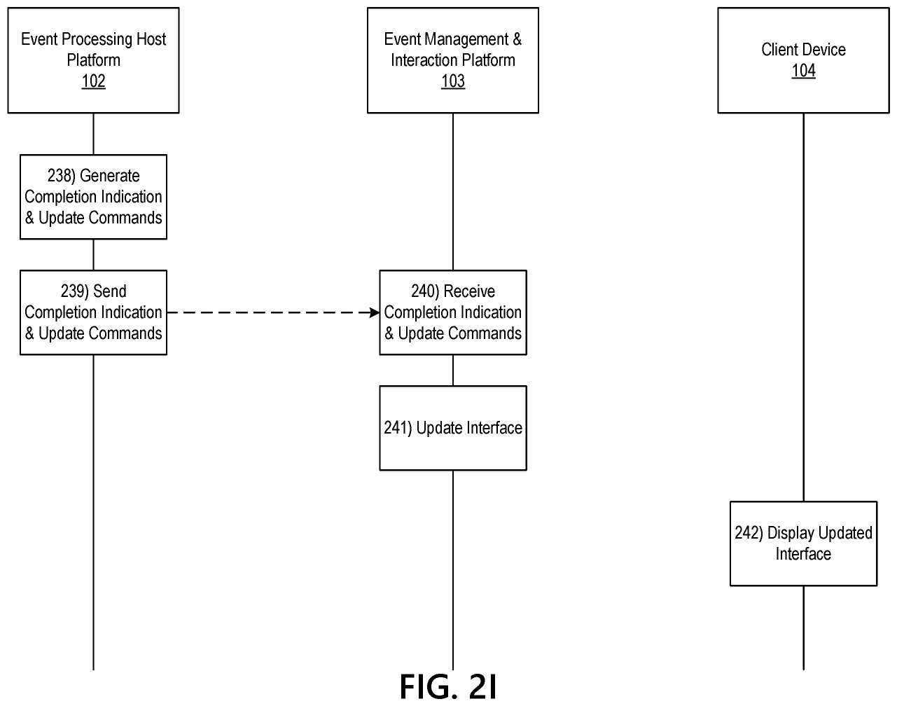

FIGS. 2A-2I depict an illustrative event sequence for deploying an enhanced processing system that controls digital check generation and processing in accordance with one or more example embodiments. Referring to FIG. 2A, at step 201, the event processing host platform 102 may receive a payment indication requesting that a digital check image be generated corresponding to a payment and a payee. In one or more instances, in receiving the payment indication, the event processing host platform 102 may receive a request to generate a digital check image corresponding to a business to business transaction. In other instances, in receiving the payment indication, the event processing host platform 102 may receive a request to generate a digital check image corresponding to a personal check. In one or more instances, the event processing host platform 102 may receive the payment indication by receiving a user input via a display screen of the event processing host platform 102.

At step 202, the event processing host platform 102 may determine the payee based on the payment indication. In one or more instances, the event processing host platform 102 may access a stored database of payee information to determine accounts corresponding to the payee specified in the payment indication. In one or more instances, payees may pre-register for the digital check image service, and may provide their account information, which may subsequently be stored by the event processing host platform 102. Additionally or alternatively, the payees may provide identification information such as a phone number, an email address, or the like when registering for the digital check image service.

At step 203, the event processing host platform 102 may generate a digital check image based on the payment indication and the payee. In generating the digital check image, the event processing host platform 102 may generate digital images corresponding to a front and a back of a check. In one or more instances, in generating the digital check image, the event processing host platform 102 may generate digital images that resemble a physical check. In one or more instances, in generating the digital check image, the event processing host platform 102 may perform similar steps. At step 204, the event processing host platform 102 may generate one or more commands directing the event management and interaction platform 103 to store the digital check image.

Referring to FIG. 2B, at step 205, the event processing host platform 102 may establish a connection with the event management and interaction platform 103. In one or more instances, the event processing host platform may establish a first wireless data connection with the event management and interaction platform 103 to link the event processing host platform 102 to the event management and interaction platform 103.

At step 206, the event processing host platform 102 may encrypt the digital check image generated at step 203. In one or more instances, the event processing host platform 102 may encrypt the digital check image using techniques that may allow the digital check image to be decrypted only by the event management and interaction platform 103. Accordingly, in one or more instances where the digital check image is intercepted during transmission and/or otherwise hacked, the digital check image may be inaccessible to the intercepting device. This may ensure the security of the digital check image, and the corresponding funds, as the digital check image is sent to be accessed by the payee. In one or more instances, the event processing host platform 102 and the event management and interaction platform 103 may maintain symmetric keys and/or execute various key generation algorithms, which may be used for encryption and decryption of the digital check image.

At step 207, the event processing host platform 102 may send the encrypted digital check image and the one or more commands directing the event management and interaction platform 103 to store the digital check image. In one or more instances, the event processing host platform 102 may send the encrypted digital check image and the one or more commands directing the event management and interaction platform 103 to store the digital check image while the first wireless data connection is established.

At step 208, the event management and interaction platform 103 may receive the encrypted digital check image and the one or more commands directing the event management and interaction platform 103 to store the digital check image. In one or more instances, the event management and interaction platform 103 may receive the encrypted digital check image and the one or more commands directing the event management and interaction platform 103 to store the digital check image via the communication interface 113 while the first wireless data connection is established.

At step 209, the event management and interaction platform 103 may decrypt the encrypted check image. In one or more instances, the event management and interaction platform 103 may use a symmetric key to decrypt the encrypted check image. Additionally or alternatively, the event management and interaction platform 103 may initiate a key exchange protocol (e.g., Diffie-Hellman, or the like), which may be used to generate a decryption key and ultimately decrypt the encrypted digital check image.

Referring to FIG. 2C, at step 210, the event management and interaction platform 103 may store the digital check image that was decrypted at step 209. In one or more instances, the event management and interaction platform 103 may store the digital check image in the event management and interaction database 112b, which may be an online banking database and may be used to host information used to generate online banking interfaces. By storing the digital check image, the event management and interaction platform 103 may make the digital check image accessible by the client device 104 through the online banking interface.

At step 211, the event management and interaction platform 103 may generate a check notification to indicate the digital check image to the payee. At step 212, the event management and interaction platform 103 may cause the check notification to be associated with an online banking account of the payee. In one or more instances, the event management and interaction platform 103 may maintain a database of payee identifications and their corresponding online banking account information. Accordingly, the event management and interaction platform 103 may cause the check notification generated at step 211 to be displayed on an online banking interface corresponding to the online banking account of the payee. In one or more instances, the event management and interaction platform 103 may use an email address, a phone number, a user identification, an account number, or the like to cause the check notification to be associated with the online banking account of the payee.

At step 213, the client device 104 may receive user input requesting access to the online banking account. In one or more instances, the client device 104 may receive the user input requesting access to the online banking account through a display of the client device 104. In one or more instances, in receiving the user input requesting access to the online banking account, the client device 104 may receive access credentials (e.g., user name, password, security token, or the like) corresponding to the payee.

Referring to FIG. 2D, at step 214, the event management and interaction platform 103 may establish a connection with the client device 104. In one or more instances, the event management and interaction platform 103 may establish a second wireless data connection with the client device 104 to link the event management and interaction platform 103 with the client device 104.

At step 215, the client device 104 may generate an online banking access request based on the user input requesting access to the online banking account received at step 213. At step 216, the client device may send the online banking access request to the event management and interaction platform 103. In one or more instances, the client device 104 may send the online banking access request to the event management and interaction platform 103 while the second wireless data connection is established. In one or more instances, in sending the online banking access request, the client device may send the access credentials received at step 213.

At step 217, the event management and interaction platform 103 may receive the online banking access request sent at step 216. In one or more instances, the event management and interaction platform 103 may receive the online banking access request via the communication interface 113 while the second wireless data connection is established.

At step 218, the event management and interaction platform 103 may verify the access credentials corresponding to the payee. If the event management and interaction platform 103 is unable to verify the access credentials, it may request additional credentials from the client device. If the event management and interaction platform 103 is able to verify the access credentials, the event management and interaction platform may proceed to step 219.

Referring to FIG. 2E, at step 219, after verifying the access credentials, the event management and interaction platform 103 may grant the client device 104 access to the online banking account. At step 220, the event management and interaction platform 103 may generate online banking interface information and one or more commands directing the client device 104 to generate an online banking interface using the online banking interface information (e.g., based on granting the client device 104 access to the online banking account).

At step 221, the event management and interaction platform 103 may send the online banking interface information and one or more commands directing the client device 104 to generate an online banking interface using the online banking interface information to the client device 104. In one or more instances, the event management and interaction platform 103 may send the online banking interface information and one or more commands directing the client device 104 to generate an online banking interface using the online banking interface information via the communication interface 113 and while the second wireless data connection is established.

At step 222, the client device 104 may receive the online banking interface information and one or more commands directing the client device 104 to generate an online banking interface using the online banking interface information. In one or more instances, the client device 104 may receive the online banking interface information and one or more commands directing the client device 104 to generate an online banking interface using the online banking interface information while the second wireless data connection is established.

At step 223, the client device 104 may generate and display an online banking interface using the online banking interface information received at step 222. In displaying the online banking interface, the client device 104 may display an interface that may allow the payee to view existing balances in their accounts, transfer funds, or the like. In one or more instances, in displaying the online banking interface, the client device 104 may display the check notification generated at step 211. In these instances, the client device 104 may display a check notification icon on the online banking interface that may be selectable by the payee.

Referring to FIG. 2F, at step 224, the client device 104 may receive a notification selection input indicating a selection of the check notification. In one or more instances, the client device 104 may receive the notification selection input via a display of the client device.

At step 225, in response to receiving the notification selection input at step 224, the client device 104 may display a link corresponding to the digital check image. At step 226, the client device 104 may receive a link selection input corresponding to a selection of the link and a request to access the digital check image. At step 227, the client device 104 may access the digital check image, stored at the event management and interaction platform 103, and may load the digital check image for display.

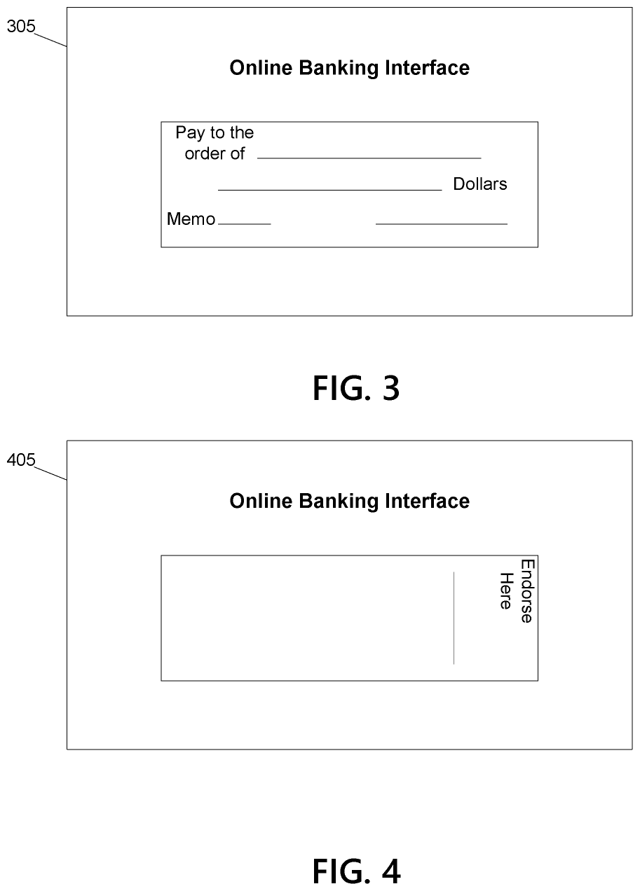

Referring to FIG. 2G, at step 228, the client device 104 may display the digital check image as part of the online banking interface. In one or more instances, in displaying the digital check image, the client device 104 may display a graphical user interface similar to graphical user interface 305, which is displayed in FIG. 3. For instance, the graphical user interface 305 may include a digital representation of a check. Although the graphical user interface 305 shows a blank check, it should be understood the graphical user interface 305 may include a check that identifies a payee, a payor, an amount to be transferred, or the like.

Additionally, in displaying the digital check image, the client device 104 may display a graphical user interface similar to graphical user interface 405, which is displayed in FIG. 4. For instance, the graphical user interface 405 may include a digital representation of a back of the check. In some instances, client device 104 may switch from displaying graphical user interface 305 (e.g., corresponding to the front of the check) to displaying graphical user interface 405 (e.g., corresponding to the back of the check) in response to receiving input indicating that the user of the client device 104 has physically rotated the client device 104 from a portrait orientation to a landscape orientation, or vice versa. Accordingly, a payee may be able to rotate the digital check image, shown in the graphical user interface 305, to display the graphical user interface 405. Accordingly, as is discussed below, the payee may be able to endorse the digital check image.

At step 229, the client device 104 may receive an endorsement input corresponding to an endorsement of the digital check image. In one or more instances, in receiving the endorsement input, the client device 104 may receive an electronic signature, an authentication stamp, or the like. In one or more instances, the client device 104 may receive the endorsement input while displaying the back of the digital check image (e.g., the graphical user interface 405). In some instances, the client device 104 may determine that an endorsement input might not be necessary to cause execution of the payment indicated by the digital check image. In these instances, the client device 104 may proceed to step 234 without receiving the endorsement input.

At step 230, the client device 104 may generate and send a check endorsement indication based on the endorsement input received at step 230. In one or more instances, the client device 104 may send the check endorsement indication to the event management and interaction platform 103 while the second wireless data connection is established.

At step 231, the event management and interaction platform 103 may receive the check endorsement indication from the client device 104. In one or more instances, the event management and interaction platform 103 may receive the check endorsement indication via the communication interface 113 and while the second wireless data connection is established.

At step 232, after receiving the check endorsement indication, the event management and interaction platform 103 may update the stored digital check image to reflect that it has been endorsed. In some instances, in updating the digital check image, the event management and interaction platform 103 may update the digital check image to include the electronic signature of the payee.

Referring to FIG. 2H, at step 233, the event management and interaction platform 103 may store the updated digital check image. In one or more instances, the event management and interaction platform 103 may replace the original digital check image with the updated digital check image. In one or more instances, the event management and interaction platform 103 may store the updated digital check image for a predetermined period of time (e.g., thirty days, ninety days, or the like), and then may delete the updated digital check image.

At step 234, the event management and interaction platform may generate one or more commands directing the event processing host platform 102 to execute the payment indicated by the digital check image. At step 235, the event management and interaction platform 103 may send the one or more commands directing the event processing host platform 102 to execute the payment indicated by the digital check image. In one or more instances, the event management and interaction platform 103 may send one or more commands directing the event processing host platform 102 to execute the payment indicated by the digital check image via the communication interface 113 while the first wireless data connection is established.

At step 236, the event processing host platform 102 may receive the one or more commands directing the event processing host platform 102 to execute the payment indicated by the digital check image. In one or more instances, the event processing host platform 102 may receive the one or more commands directing the event processing host platform 102 to execute the payment indicated by the digital check image while the first wireless data connection is established.

At step 237, in response to the one or more commands directing the event processing host platform 102 to execute the payment indicated by the digital check image received at step 236, the event processing host platform 102 may cause a fund transfer, from the payor's account to the payee's account, of an amount specified by the digital check image. For example, the event processing host platform 102 may update one or more account tables or other records associated with the accounts and/or may command and control other systems and/or databases to facilitate the funds transfer.

Referring to FIG. 2I, at step 238, the event processing host platform 102 may generate a payment completion indication and one or more commands directing the event management and interaction platform 103 to update the online banking interface information based on the payment completion indication. At step 239, the event processing host platform 102 may send the payment completion indication and one or more commands directing the event management and interaction platform 103 to update the online banking interface information based on the payment completion indication. In one or more instances, the event processing host platform 102 may send the payment completion indication and one or more commands directing the event management and interaction platform 103 to update the online banking interface information based on the payment completion indication while the first wireless data connection is established.

At step 240, the event management and interaction platform 103 may receive the payment completion indication and one or more commands directing the event management and interaction platform 103 to update the online banking interface information based on the payment completion indication sent at step 239. In one or more instances, the event processing host platform 102 may send the payment completion indication and one or more commands directing the event management and interaction platform 103 to update the online banking interface information based on the payment completion indication via the communication interface 113 while the first wireless data connection is established.

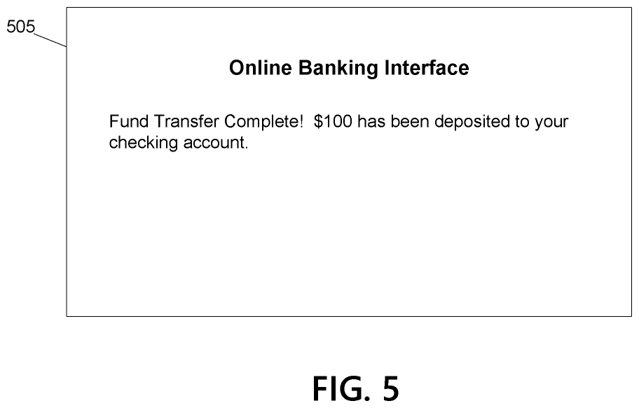

At step 241, the event management and interaction platform 103 may update the online banking interface information based on the completion indication. At step 242, the client device 104 may update the online banking interface based on the updated online banking interface information from step 241, and may display the updated online banking interface. In one or more instances, in displaying the updated online banking interface, the client device 104 may display a graphical user interface similar to graphical user interface 505, which is shown in FIG. 5. In one or more instances, graphical user interface 505 may indicate that the payment corresponding to the digital check image has been completed, and may indicate the funds transferred.

Subsequently, the event sequence may end, and the event management and interaction platform 103 may continue to facilitate the generation, authentication, and processing of other digital check images between the same and/or other event processing host platforms and the same and/or other client devices. In providing the digital check images, the event management and interaction platform 103 may increase information security and data integrity in computing operations associated with check payments. Furthermore, by providing the digital check images, the event management and interaction platform 103 may reduce payment processing times by eliminating the delay caused by mailing a physical check to a payee. In addition, by providing the digital check images, the event management and interaction platform 103 may reduce the cost of check processing by eliminating the purchase of materials used to make the physical check (e.g., ink, paper, or the like).

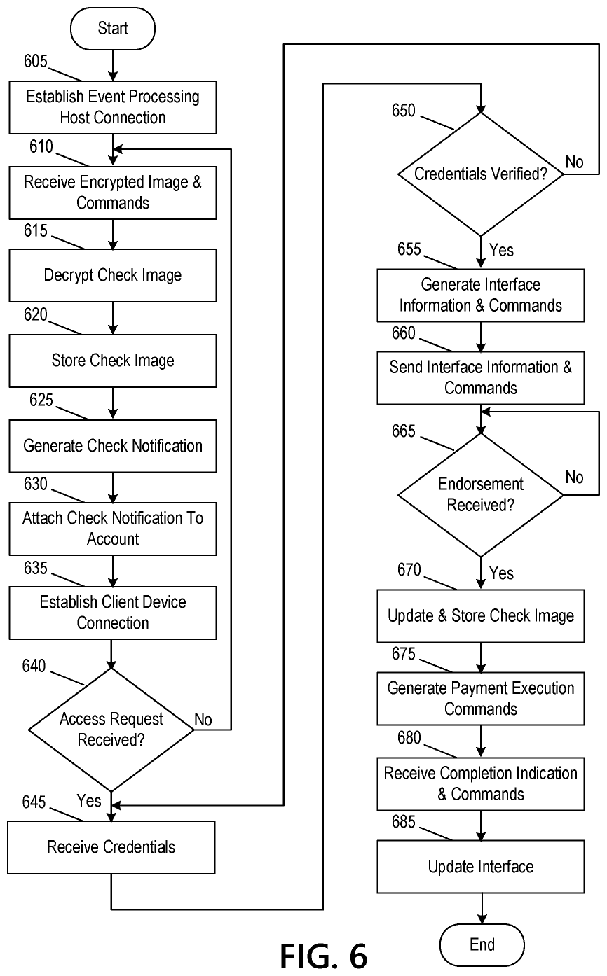

FIG. 6 depicts an illustrative method for deploying an enhanced processing system that controls digital check generation and processing in accordance with one or more example embodiments. Referring to FIG. 6, at step 605, a computing platform having at least one processor, a communication interface, and memory may establish a connection with an event processing host platform. At step 610, the computing platform may receive an encrypted digital check image and one or more commands directing the computing platform to store the encrypted digital check image. At step 615, the computing platform may decrypt the encrypted digital check image. At step 620, the computing platform may store the decrypted digital check image. At step 625, the computing platform may generate a notification of the decrypted digital check image. At step 630, the computing platform may associate the check notification with an account of the payee indicated on the digital check image. At step 635, the computing platform may establish a connection with a client device. At step 640, the computing platform may determine whether an online banking access request was received. If an online banking access request was not received, the computing platform may return to step 610. If an online banking access request was received, the computing platform may proceed to step 645.

At step 645, the computing platform may receive access credentials for the online banking access request. At step 650, the computing platform may determine whether the access credentials are verified. If the access credentials are not verified, the computing platform may return to step 640. If the access credentials are verified, the computing platform may proceed to step 655.

At step 655, the computing platform may generate online banking interface information and one or more commands directing the client device to display an online banking interface based on the online banking interface information. At step 660, the computing platform may send the online banking interface information and the one or more commands directing the client device to display the online banking interface based on the online banking interface information. At step 665, the computing platform may determine whether an indication of an endorsement was received. If an indication of an endorsement was not received, the computing platform may wait until an indication of an endorsement is received before proceeding. If an indication of an endorsement was received, the computing platform may proceed to step 670.

At step 670, the computing platform may update the digital check image based on the indication of the endorsement, and may store the updated digital check image. At step 675, the computing platform may generate one or more commands directing the event processing host platform to execute a payment associated with the updated digital check image. At step 680, the computing platform may receive an indication that the payment was completed and one or more commands to update the online banking interface information based on the indication that the payment was completed. At step 685, the computing platform may update the online banking interface information based on the indication that the payment was completed.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising:
at least one processor;
a communication interface communicatively coupled to the at least one processor; and
memory storing computer-readable instructions that, when executed by the at least one processor, cause the computing platform to:
receive, from an event processing host platform and in response to an indication of a payment, an encrypted digital check image corresponding to the payment and one or more commands directing the computing platform to store the encrypted digital check image, wherein the encrypted digital check image comprises digital image data corresponding to a front of a check and a back of the check;
decrypt the encrypted digital check image, resulting in a decrypted digital check image;
store the decrypted digital check image for access through an online banking portal hosted by the computing platform;
generate a notification containing a link to the decrypted digital check image, wherein the notification is accessible through the online banking portal hosted by the computing platform;
generate online banking interface information and one or more commands directing a client device to display an online banking interface using the online banking interface information, wherein the online banking interface includes the notification;
send, to the client device, the online banking interface information and the one or more commands directing the client device to display the online banking interface using the online banking interface information, wherein sending the online banking interface information and the one or more commands directing the client device to display the online banking interface using the online banking interface information causes the client device to:
display, within the online banking portal hosted by the computing platform, a first online banking interface corresponding to the front of the check when the client device is in a portrait orientation; and
switch to displaying, within the online banking portal hosted by the computing platform, a second online banking interface corresponding to the back of the check when the client device is physically rotated from the portrait orientation to a landscape orientation;
receive, from the client device, a check endorsement indication corresponding to the decrypted digital check image; and
update the decrypted digital check image to include an endorsement image based on the check endorsement indication.

2. The computing platform of claim 1, wherein the memory stores additional computer-readable instructions that, when executed by the at least one processor, further cause the computing platform to:
generate, based on the check endorsement indication, one or more commands directing the event processing host platform to cause a transfer of funds corresponding to the payment; and
send, to the event processing host platform, the one or more commands directing the event processing host platform to cause the transfer of funds corresponding to the payment.

3. The computing platform of claim 1, wherein the memory stores additional computer-readable instructions that, when executed by the at least one processor, further cause the computing platform to:
establish a wireless data connection with the event processing host platform, wherein the encrypted digital check image is received while the wireless data connection with the event processing host platform is established.

4. The computing platform of claim 1, wherein the memory stores additional computer-readable instructions that, when executed by the at least one processor, further cause the computing platform to:
determine a payee corresponding to the payment; and
establish a correlation between the payee and the notification, wherein establishing the correlation causes the notification to be displayed in an online banking account corresponding to the payee.

5. The computing platform of claim 1, wherein the memory stores additional computer-readable instructions that, when executed by the at least one processor, further cause the computing platform to:
establish a wireless data connection with the client device, wherein the check endorsement indication corresponding to the decrypted digital check image is received while the wireless data connection with the client device is established.

6. The computing platform of claim 1, wherein the memory stores additional computer-readable instructions that, when executed by the at least one processor, further cause the computing platform to:
receive, from the client device, a request to access an online banking account of a payee corresponding to the payment, wherein the request to access the online banking account corresponding to the payee includes login credentials; and
verify, before generating the online banking interface information and the one or more commands directing the client device to display the online banking interface using the online banking interface information, the login credentials.

7. (canceled)

8. The computing platform of claim 1, wherein the memory stores additional computer-readable instructions that, when executed by the at least one processor, further cause the computing platform to:
store, after updating the decrypted digital check image to include the endorsement image based on the check endorsement indication, the updated decrypted digital check image.

9. The computing platform of claim 1, wherein the memory stores additional computer-readable instructions that, when executed by the at least one processor, further cause the computing platform to:
receive an indication from the event processing host platform indicating that payment was executed and one or more commands directing the computing platform to update the online banking interface to reflect the executed payment; and
update the online banking interface to reflect the executed payment, wherein updating the online banking interface to reflect the executed payment causes the client device to display the updated online banking interface.

10. A method comprising:
at a computing platform comprising at least one processor, a communication interface, and memory:
receiving, from an event processing host platform and in response to an indication of a payment, an encrypted digital check image corresponding to the payment and one or more commands directing the computing platform to store the encrypted digital check image, wherein the encrypted digital check image comprises digital image data corresponding to a front of a check and a back of the check;
decrypting the encrypted digital check image, resulting in a decrypted digital check image;
storing the decrypted digital check image for access through an online banking portal hosted by the computing platform;
generating a notification containing a link to the decrypted digital check image, wherein the notification is accessible through the online banking portal hosted by the computing platform;
generating online banking interface information and one or more commands directing a client device to display an online banking interface using the online banking interface information, wherein the online banking interface includes the notification;
sending, to the client device, the online banking interface information and the one or more commands directing the client device to display the online banking interface using the online banking interface information, wherein sending the online banking interface information and the one or more commands directing the client device to display the online banking interface using the online banking interface information causes the client device to:
display, within the online banking portal hosted by the computing platform, a first online banking interface corresponding to the front of the check when the client device is in a portrait orientation; and
switch to displaying, within the online banking portal hosted by the computing platform, a second online banking interface corresponding to the back of the check when the client device is physically rotated from the portrait orientation to a landscape orientation;
receiving, from the client device, a check endorsement indication corresponding to the decrypted digital check image; and
updating the decrypted digital check image to include an endorsement image based on the check endorsement indication.

11. The method of claim 10, further comprising:
generating, based on the check endorsement indication, one or more commands directing the event processing host platform to cause a transfer of funds corresponding to the payment; and
sending, to the event processing host platform, the one or more commands directing the event processing host platform to cause the transfer of funds corresponding to the payment.

12. The method of claim 10, further comprising:
establishing a wireless data connection with the event processing host platform, wherein the encrypted digital check image is received while the wireless data connection with the event processing host platform is established.

13. The method of claim 10, further comprising:
determining a payee corresponding to the payment; and
establishing a correlation between the payee and the notification, wherein establishing the correlation causes the notification to be displayed in an online banking account corresponding to the payee.

14. The method of claim 10, further comprising:
establishing a wireless data connection with the client device, wherein the check endorsement indication corresponding to the decrypted digital check image is received while the wireless data connection with the client device is established.

15. The method of claim 10, further comprising:
receiving, from the client device, a request to access an online banking account of a payee corresponding to the payment, wherein the request to access the online banking account corresponding to the payee includes login credentials; and
verifying, before generating the online banking interface information and the one or more commands directing the client device to display the online banking interface using the online banking interface information, the login credentials.

16. (canceled)

17. The method of claim 10, further comprising:
storing, after updating the decrypted digital check image to include the endorsement image based on the check endorsement indication, the updated decrypted digital check image.

18. The method of claim 10, further comprising:
receiving an indication from the event processing host platform indicating that payment was executed and one or more commands directing the computing platform to update the online banking interface to reflect the executed payment; and
updating the online banking interface to reflect the executed payment, wherein updating the online banking interface to reflect the executed payment causes the client device to display the updated online banking interface.

19. One or more non-transitory computer-readable media storing instructions that, when executed by a computing platform comprising at least one processor, a communication interface, and memory, cause the computing platform to:
receive, from an event processing host platform and in response to an indication of a payment, an encrypted digital check image corresponding to the payment and one or more commands directing the computing platform to store the encrypted digital check image, wherein the encrypted digital check image comprises digital image data corresponding to a front of a check and a back of the check;
decrypt the encrypted digital check image, resulting in a decrypted digital check image;
store the decrypted digital check image for access through an online banking portal hosted by the computing platform;
generate a notification containing a link to the decrypted digital check image, wherein the notification is accessible through the online banking portal hosted by the computing platform;
generate online banking interface information and one or more commands directing a client device to display an online banking interface using the online banking interface information, wherein the online banking interface includes the notification;
send, to the client device, the online banking interface information and the one or more commands directing the client device to display the online banking interface using the online banking interface information, wherein sending the online banking interface information and the one or more commands directing the client device to display the online banking interface using the online banking interface information causes the client device to:
display, within the online banking portal hosted by the computing platform, a first online banking interface corresponding to the front of the check when the client device is in a portrait orientation; and
switch to displaying, within the online banking portal hosted by the computing platform, a second online banking interface corresponding to the back of the check when the client device is physically rotated from the portrait orientation to a landscape orientation;
receive, from the client device, a check endorsement indication corresponding to the decrypted digital check image; and
update the decrypted digital check image to include an endorsement image based on the check endorsement indication.

20. The one or more non-transitory computer-readable media of claim 19, wherein the memory stores additional computer-readable instructions that, when executed by the at least one processor, further cause the computing platform to:
generate, based on the check endorsement indication, one or more commands directing the event processing host platform to cause a transfer of funds corresponding to the payment; and
send, to the event processing host platform, the one or more commands directing the event processing host platform to cause the transfer of funds corresponding to the payment.
